(19) United States
(12) Patent Application Publication
(10) Pub. No.: US 2004/0173667 A1
(43) Pub. Date: Sep. 9, 2004

(54) Connecting method of wheel rim of bicycle

(76) Inventor: Lai-Chien Chen, Chang Hua Hsien (TW)

Correspondence Address: CHARLES E. BAXLEY, ESQUIRE, Fifth Floor, 59 John Street, New York, NY, 10038, US

(21) Appl. No.: 10/379,813

(22) Filed: Mar. 5, 2003

(51) Int. Cl. B23K 31/00

(52) U.S. Cl. 228/245; 228/246; 228/248.1

(57) ABSTRACT

A connecting method of a wheel rim of a bicycle includes the following steps: forming a wheel rim, inserting an inner connecting member between two abutment ends of the wheel rim, connecting the two abutment ends, heating, packing, permeating, and returning. Thus, the structural strength of the wheel rim is enhanced, thereby increasing the lifetime of the wheel rim. In addition, the connecting seam of the two abutment ends will not form a protruding rough bur, so that it is unnecessary to perform a secondary working process to grind the surface of the connecting seam of the two abutment ends, thereby simplifying the working process of the wheel rim, and thereby decreasing costs of fabrication.

### BACKGROUND OF THE INVENTION

1. Field of the Invention

The present invention relates to a connecting method of a wheel rim of a bicycle, and more particularly to a connecting method of a wheel rim of a bicycle, wherein the structural strength of the wheel rim is enhanced, thereby increasing the lifetime of the wheel rim.

2. Description of the Related Art

A conventional wheel rim 10 of a bicycle in accordance with the prior art shown in FIG. 1 has a periphery formed with a plurality of through holes 11 for locking spoke wires 12 by locking members 13. The wheel rim 10 has two abutment ends 15 each formed with an insertion hole 16, and an inner connecting member 17 is inserted into the insertion hole 16 of each of the two abutment ends 15 of the wheel rim 10. Thus, the two abutment ends 15 of the wheel rim 10 are connected together to form the whole wheel rim 10.

As shown in FIG. 2, the two abutment ends 15 of the wheel rim 10 are connected by a conventional method described as follows. A high voltage current passes through the two ends of the wheel rim 10, so that the two abutment ends 15 of the wheel rim 10 hit each other. At this time, the two abutment ends 15 of the wheel rim 10 are disposed at a melted state due to the high voltage current, so that the two abutment ends 15 of the wheel rim 10 are welded together.

However, the two abutment ends 15 of the wheel rim 10 are heated and melted during the connecting process, so that the integrity of the crystalline phase is broken, thereby weakening the structural strength of the two abutment ends 15 of the wheel rim 10. In addition, if the two abutment ends 15 of the wheel rim 10 are not welded completely, the connecting seams of the two abutment ends 15 of the wheel rim 10 will form multiple air pores which decreases the connecting strength of the two abutment ends 15 of the wheel rim 10, so that the two abutment ends 15 of the wheel rim 10 are detached easily. Further, the connecting seams of the two abutment ends 15 of the wheel rim 10 will form a protruding rough bur 18 after the two abutment ends 15 of the wheel rim 10 hit each other, so that it is necessary to perform a secondary working process so, as to grind and polish the protruding rough bur 18. Thus, the surface layer of the two abutment ends 15 of the wheel rim 10 is rubbed by the secondary working process, thereby decreasing the strength of the wheel rim 10, so that it is necessary to perform a hardening treatment to harden the wheel rim 10, thereby increasing costs of fabrication.

As shown in FIG. 3, according to another conventional connecting method, the connecting portions of the two abutment ends 15A of the wheel rim 10A are heated by a solder 25. In such a manner, the solder 25 is melted by the current, so that the melted solder 25 can weld the two abutment ends 15A of the wheel rim 10A. However, the solder material of the solder 25 is left on the connecting portions of the two abutment ends 15A of the wheel rim 10A. In addition, the stress concentration will produce at the connecting portions of the two abutment ends 15A of the wheel rim 10A.

### SUMMARY OF THE INVENTION

The present invention is to mitigate and/or obviate the disadvantage of the conventional connecting methods of a wheel rim of a bicycle.

The primary objective of the present invention is to provide a connecting method of a wheel rim of a bicycle, wherein the structural strength of the wheel rim is enhanced, thereby increasing the lifetime of the wheel rim.

Another objective of the present invention is to provide a connecting method of a wheel rim of a bicycle, wherein the area and strength of the connecting region of the two abutment ends of the wheel rim are increased without producing air pores.

A further objective of the present invention is to provide a connecting method of a wheel rim of a bicycle, wherein the connecting seam of the two abutment ends of the wheel rim will not form a protruding rough bur, so that it is unnecessary to perform a secondary working process to grind and polish the surface of the connecting seam of the two abutment ends of the wheel rim, thereby simplifying the working process of the wheel rim, and thereby decreasing costs of fabrication.

In accordance with the present invention, there is provided a connecting method of a wheel rim of a bicycle, comprising the steps of:

forming a wheel rim by rolling a bar made of aluminum;

inserting an inner connecting member between two abutment ends of the wheel rim;

connecting the two abutment ends of the wheel rim with a connecting gap being formed between the two abutment ends of the wheel rim;

heating: providing a plurality of fire ejection guns around a periphery of the connecting gap between the two abutment ends of the wheel rim, to heat the connecting gap between the two abutment ends of the wheel rim successively to a first temperature under the melting point of the wheel rim;

packing: placing an aluminum alloy solder into the connecting gap between the two abutment ends of the wheel rim, so that the aluminum alloy solder is melted to flow into the connecting gap between the two abutment ends of the wheel rim and into pores of the wheel rim;

permeating: heating the wheel rim successively to a second temperature under the melting point of the wheel rim, so that the aluminum alloy solder is disposed at a high temperature state to permeate through the connecting gap between the two abutment ends of the wheel rim, through a gap between the wheel rim and the inner connecting member and through the pores of the wheel rim; and

returning: stopping heating the wheel rim, so that the wheel rim is returned to the ambient temperature.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view showing the connecting structure of a first conventional wheel rim of a bicycle in accordance with the prior art;

FIG. 2 is a perspective assembly view of the connecting structure of the first conventional wheel rim of a bicycle in accordance with the prior art;

FIG. 3 is a side plan view showing the connecting structure of a second conventional wheel rim of a bicycle in accordance with the prior art;

FIG. 4 is a side plan view showing the heating step of a connecting method of a wheel rim of a bicycle in accordance with the preferred embodiment of the present invention;

FIG. 5 is a perspective view showing the permeation step of the connecting method of the wheel rim of a bicycle in accordance with the preferred embodiment of the present invention;

FIG. 5A is a partially enlarged view of the wheel rim as shown in FIG. 5; and

FIG. 6 is a plan cross-sectional view of the wheel rim as shown in FIG. 5.

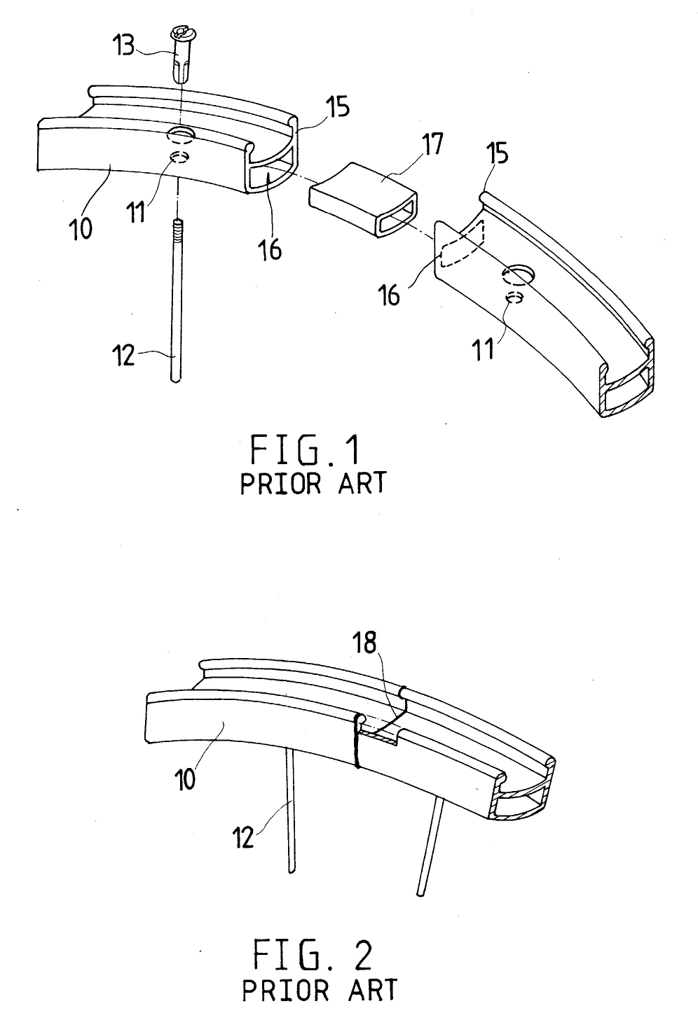

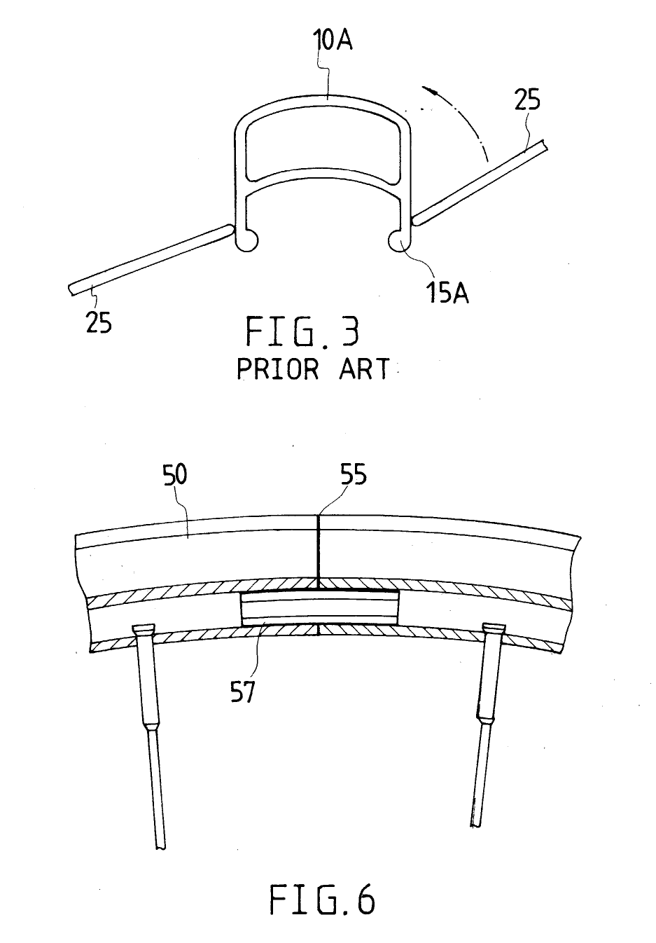

### DETAILED DESCRIPTION OF THE INVENTION

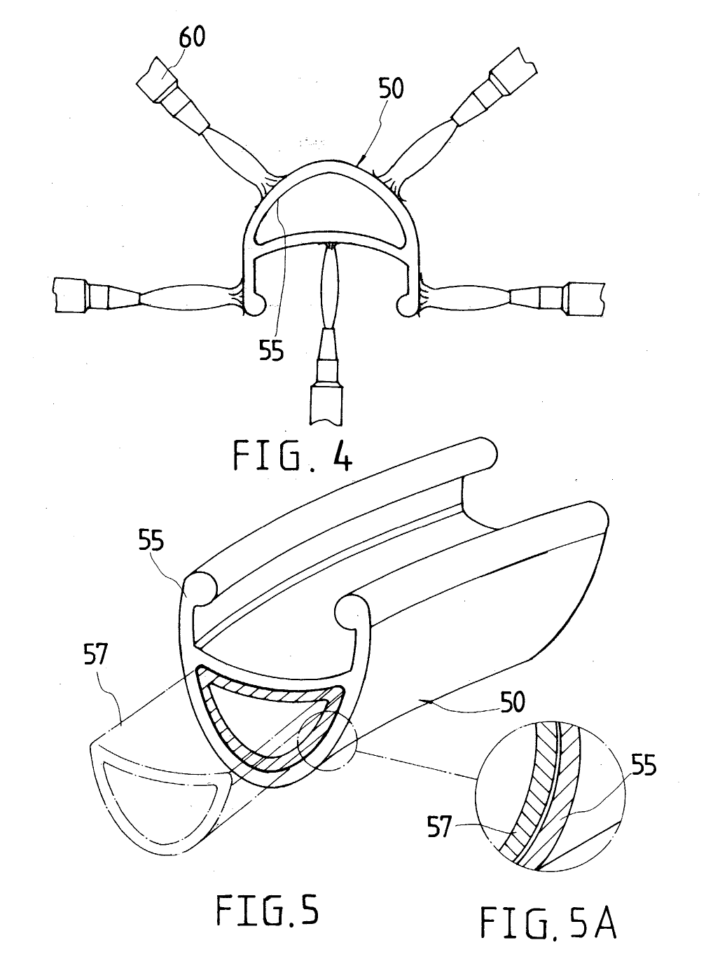

Referring to FIGS. 4-6, a connecting method of a wheel rim of a bicycle in accordance with the preferred embodiment of the present invention comprises the following steps:

forming a wheel rim 50 by rolling a bar made of aluminum;

inserting an inner connecting member 57 between two abutment ends 55 of the wheel rim 50;

connecting the two abutment ends 55 of the wheel rim 50 with a connecting gap being formed between the two abutment ends 55 of the wheel rim 50;

heating: providing a plurality of fire ejection guns 60 around a periphery of the connecting gap between the two abutment ends 55 of the wheel rim 50, to heat the connecting gap between the two abutment ends 55 of the wheel rim 50 successively to the temperature which is about 100° C. to 150° C. under the melting point (about 500° C. to 560° C.) of the wheel rim 50, so that the two abutment ends 55 of the wheel rim 50 are not melted, thereby preventing the crystalline phase of the wheel rim 50 from being broken;

packing: placing a paste shaped or stick shaped aluminum alloy solder (preferably, the aluminum alloy solder is a special solder of aluminum alloy 4047) into the connecting gap between the two abutment ends 55 of the wheel rim 50, so that the aluminum alloy solder is melted to flow into the connecting gap between the two abutment ends 55 of the wheel rim 50 and into pores of the wheel rim 50 to perform the packing process;

permeating: heating the wheel rim 50 successively to a temperature under the melting point of the wheel rim 50, so that the aluminum alloy solder is disposed at the high temperature state to permeate through the connecting gap between the two abutment ends 55 of the wheel rim 50, through a gap between the wheel rim 50 and the inner connecting member 57 and through the pores of the wheel rim 50 as shown in FIGS. 5, 5A and 6, so that the aluminum alloy solder is entirely filled with the connecting gap between the two abutment ends 55 of the wheel rim 50, the gap between the wheel rim 50 and the inner connecting member 57 and filled with the pores of the wheel rim 50, thereby enlarging the soldering area; and

returning: stopping heating the wheel rim 50, so that the wheel rim 50 is returned to the ambient temperature.

In such a manner, the heating temperature does not reach the melting point (about 500° C. to 560° C.) of the wheel rim 50, so that the crystalline phase of the two abutment ends 55 of the wheel rim 50 is not broken, thereby preventing from weakening the structural strength of the two abutment ends 55 of the wheel rim 50, and thereby enhancing the structural strength of the wheel rim 50.

In addition, the aluminum alloy solder is entirely filled with the connecting gap between the two abutment ends 55 of the wheel rim 50, the gap between the wheel rim 50 and the inner connecting member 57 and filled with the pores of the wheel rim 50, thereby increasing the area and strength of the connecting region of the two abutment ends 55 of the wheel rim 50 without producing air pores.

Further, the aluminum alloy solder is entirely filled with the connecting gap between the two abutment ends 55 of the wheel rim 50 at a high temperature, so that the connecting seam of the two abutment ends 55 of the wheel rim 50 will not form a protruding rough bur. Thus, it is unnecessary to perform a secondary working process to grind and polish the surface of the connecting seam of the two abutment ends 55 of the wheel rim 50, thereby simplifying the working process of the wheel rim 50, and thereby decreasing costs of fabrication.

While the preferred embodiment(s) of the present invention has been shown and described, it will be apparent to those skilled in the art that various modifications may be made in the embodiment(s) without departing from the spirit of the present invention. Such modifications are all within the scope of the present invention.

What is claimed is:

1. A connecting method of a wheel rim of a bicycle, comprising the steps of:
forming a wheel rim by rolling a bar made of aluminum;
inserting an inner connecting member between two abutment ends of the wheel rim;
connecting the two abutment ends of the wheel rim with a connecting gap being formed between the two abutment ends of the wheel rim;
heating: providing a plurality of fire ejection guns around a periphery of the connecting gap between the two abutment ends of the wheel rim, to heat the connecting gap between the two abutment ends of the wheel rim successively to a first temperature under the melting point of the wheel rim;
packing: placing an aluminum alloy solder into the connecting gap between the two abutment ends of the wheel rim, so that the aluminum alloy solder is melted to flow into the connecting gap between the two abutment ends of the wheel rim and into pores of the wheel rim;
permeating: heating the wheel rim successively to a second temperature under the melting point of the wheel rim, so that the aluminum alloy solder is disposed at a high temperature state to permeate through the connecting gap between the two abutment ends of the wheel rim, through a gap between the wheel rim and the inner connecting member and through the pores of the wheel rim; and
returning: stopping heating the wheel rim, so that the wheel rim is returned to the ambient temperature.

2. The connecting method of a wheel rim of a bicycle in accordance with claim 1, wherein the wheel rim is formed by rolling a bar made of aluminum.

3. The connecting method of a wheel rim of a bicycle in accordance with claim 1, wherein the first temperature is about 100° C. to 150° C. under the melting point of the wheel rim.

4. The connecting method of a wheel rim of a bicycle in accordance with claim 1, wherein the two abutment ends of the wheel rim are not melted at the first temperature, thereby preventing a crystalline phase of the wheel rim from being broken.

5. The connecting method of a wheel rim of a bicycle in accordance with claim 1, wherein the aluminum alloy solder has a paste shape.

6. The connecting method of a wheel rim of a bicycle in accordance with claim 1, wherein the aluminum alloy solder has a stick shape.

7. The connecting method of a wheel rim of a bicycle in accordance with claim 1, wherein the aluminum alloy solder is a special solder of aluminum alloy 4047.
